(19) United States
(12) Patent Application Publication
(10) Pub. No.: US 2023/0053526 A1
(43) Pub. Date: Feb. 23, 2023

(54) AUTOMATED DOOR SYSTEM

(71) Applicant: PORTAL ENTRYWAYS, INC, Provo, UT (US)

(72) Inventors: Joshua Steven Horne, Provo, UT (US); Samuel Jr-Yung Lew, Provo, UT (US); Abram Hook Early, Provo, UT (US); Justin Craig Snider, Murray, UT (US)

(73) Assignee: PORTAL ENTRYWAYS, INC, Provo, UT (US)

(21) Appl. No.: 17/982,423

(22) Filed: Nov. 7, 2022

Related U.S. Application Data
(63) Continuation of application No. PCT/US2021/032320, filed on May 13, 2021.
(60) Provisional application No. 63/023,980, filed on May 13, 2020.

(51) Int. Cl. E05F 15/77; E06B 3/46

(52) U.S. Cl. CPC E05F 15/77; E06B 3/46; E05F 2015/765

(57) ABSTRACT

An automated door system may include a first antenna, a second antenna, and a first door control module. The first antenna may be configured to be mounted to a first side of a powered door, the second antenna may be configured to be mounted to a second side of the powered door opposite the first side, and the first door control module may comprise a processor and may be configured to be mounted in a fixed position relative to the powered door. The processor may be configured to communicate with a memory having instructions stored thereon cause the automated door system to perform various operations including wirelessly connecting, by the processor, the first door control module to a second a second door control module via at least one of the first antenna and the second antenna and performing at least one actuation of the powered door.

### CROSS-REFERENCE TO RELATED APPLICATIONS

This application is a continuation of PCT International Patent Application Serial No. PCT/US2021/032320 filed May 13, 2020 entitled “AUTOMATED DOOR SYSTEM.” PCT/US2021/032320 claims priority to, and the benefit of, U.S. Provisional Application No. 63/023,980 filed May 13, 2020 entitled “AUTOMATED DOOR SYSTEM.” The disclosure of each of the foregoing applications is incorporated herein by reference in its entirety, including but not limited to those portions that specifically appear hereinafter, but except for any subject matter disclaimers or disavowals, and except to the extent that the incorporated material is inconsistent with the express disclosure herein, in which case the language in this disclosure shall control.

### BACKGROUND

Currently the best method for a wheelchair user to enter an accessible entry is to approach and push a handicap-labeled button, which causes a powered door to open. However, there are various shortcomings pertaining to this conventional system. For example, some users may have conditions that affect their entire body, such as muscular dystrophy or cerebral palsy, and these users may not possess the physical strength or ability to push the buttons. Further, handicap-labeled buttons are often positioned in awkward or out-of-the-way locations, thus making it difficult for certain users to use the entry. Such a situation may be especially problematic for schools (primary, intermediate, advanced), libraries, hospitals, malls, businesses, etc.

The shortcomings of conventional entryways are not just affecting users with disabilities. For example, stroller users, users carrying or pushing large loads (e.g., caterers, janitors, etc.), and/or elderly users have many significant unmet needs regarding the conventional, button-activated door opening systems. Further, such doors may open too slowly and/or may close too quickly. Still further, many conventional door systems fall into disrepair, thus leaving the respective entry inaccessible and thus potentially exposing the owner of the property liability under various safety and accessibility standards, for example, failure to maintain an operable entry may go against standards of the American National Standards Institute (ANSI) or the Builders Hardware Manufacturers Association (BHMA), among others. Further, an entryway in disrepair may lead to liability under the American with Disabilities Act (ADA) for failure to comply with relevant ADA standards. Various other shortcomings of conventional door systems are further described below.

Still further, conventional entryways may have various shortcomings other than those noted above regarding opening and closing powered doors. For example, conventional entryways may not be able to provide access control, may not be configured to track occupancy, entrance, and/or exit analytics, and may further be limited in their ability to automate visitor access and/or to integrate with building operating systems, among other shortcomings.

### SUMMARY

The subject matter of the present disclosure has been developed in response to the present state of the art, and in particular, in response to the problems and needs in the art that have not yet been fully solved by currently available door systems. Accordingly, the present disclosure has been developed to provide automated door systems, and related components and methods, that overcome many or all of the above-discussed shortcomings in the art, in accordance with various embodiments.

Thus, the features and elements disclosed herein may be combined in various combinations without exclusivity, unless expressly indicated herein otherwise. These features and elements as well as the operation of the disclosed embodiments will become more apparent in light of the following description and accompanying drawings.

Disclosed herein, according to various embodiments, is an automated door system that includes a first antenna, a second antenna, and a first door control module. The first antenna may be configured to be mounted to a first side of a powered door, the second antenna may be configured to be mounted to a second side of the powered door opposite the first side, and the first door control module may comprise a processor and may be configured to be mounted in a fixed position relative to the powered door. The processor may be configured to communicate with a tangible, non-transitory memory having instructions stored thereon that, in response to execution by the processor, cause the automated door system to perform various operations. The various operations may include wirelessly connecting, by the processor, the first door control module to a second a second door control module, configured to be carried by a user, via at least one of the first antenna and the second antenna. The operations may further comprise performing at least one actuation of the powered door.

In various embodiments, the at least one actuation of the powered door comprises at least one of a closing actuation, an opening actuation, an unlocking actuation, and a locking actuation. In various embodiments, the various operations comprise receiving and comparing data from the first antenna and the second antenna to determine on which side of the powered door the second door control module is located. In various embodiments, the operations comprise receiving and comparing data from the first antenna and the second antenna to determine a proximity of the user relative to the powered door. Receiving and comparing data from the first antenna and the second antenna may comprise performing an angle of arrival calculation for timing and accuracy of the at least one actuation of the powered door. In various embodiments, the receiving and comparing data from the first antenna and the second antenna comprises determining an extent of reflective signal noise and calibrating or adjusting timing and accuracy of the at least one actuation of the powered door based on the extent of the reflective signal noise.

In various embodiments, the system further includes a third door control module configured to be mounted in a fixed position relative to the powered door, wherein the third door control module is configured to be coupled to a button that is depressible for manual control of the at least one actuation of the powered door. The third door control module may comprise an electric generator mechanism that is configured to generate electricity in response to manual depression of the button. In various embodiments, the third door control module is configured to be in electronic communication with the first door control module, wherein the operations comprise at least one of tracking button depression data and reporting the button depression data to a server. In various embodiments, the system further includes a detector configured to detect a presence of the user relative to the powered door, wherein the operations comprise receiving, by the processor, position data pertaining to the user from detector, wherein performing, by the processor, the at least one actuation is performed in response to both the position data and the data from the first antenna and the second antenna.

Also disclosed herein, according to various embodiments, is an automated door system that includes a detector configured to detect a presence of a user relative to a powered door. The system may also include a first door control module comprising a processor and configured to be mounted in a fixed position relative to the powered door. The processor may be configured to communicate with a tangible, non-transitory memory having instructions stored thereon that, in response to execution by the processor, cause the automated door system to perform various operations. The various operations may comprise receiving, by the processor, position data pertaining to the user from the detector. The operations may also include controlling, by the processor, at least one actuation of the powered door based on the position data.

In various embodiments, the at least one actuation of the powered door comprises at least one of a closing actuation, an opening actuation, an unlocking actuation, and a locking actuation. In various embodiments, the detector comprises at least one of a camera, a radar detector, a lidar detectors, an infrared sensor, a microwave sensor, and a machine-perception device. In various embodiments, the system further includes a first antenna configured to be mounted to a first side of the powered door and a second antenna configured to be mounted to a second side of the powered door opposite the first side. The various operations may comprise receiving and comparing data from the first antenna and the second antenna to determine on which side of the powered door the second door control module is located. In various embodiments, the operations comprise receiving and comparing data from the first antenna and the second antenna to determine a proximity of the user relative to the powered door. In various embodiments, the receiving and comparing data from the first antenna and the second antenna comprises performing an angle of arrival calculation for timing and accuracy of the at least one actuation of the powered door.

Also disclosed herein, according to various embodiments, is a method of controlling a powered door. The method may include wirelessly electronically connecting, by at least one of a first processor of a first door control module that is mounted in a fixed position relative to the powered door and a second processor of a second door control module, the second door control module to the first door control module via a first antenna and a second antenna. The method may also include receiving, by at least one of the first processor and the second processor, data from the first antenna and the second antenna to determine on which side of the powered door the second door control module is located. The method may further include determining, by at least one of the first processor and the second processor and based on the data from the first antenna and the second antenna, a proximity of the second door control module to the first door control module. Still further, the method may include, in response to determining the proximity of the second door control module to the first door control module, actuating, by at least one of the first processor and the second processor, the powered door.

In various embodiments, the first antenna is mounted to a first side of the powered door, the second antenna is mounted to a second side of the powered door opposite the first side, and the second door control module comprises an application stored on a portable electronic device of a user and the portable electronic device comprises the second processor. In various embodiments, determining the proximity of the second door control module to the first door control module comprises performing an angle of arrival calculation of the second door control module.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Thus, although the subject matter of the present disclosure is particularly pointed out and distinctly claimed in the concluding portion of the specification, a more complete understanding of the present disclosure, may best be obtained by referring to the detailed description and claims when considered in connection with the drawing figures. Understanding that these drawings depict only typical embodiments of the disclosure and are not therefore to be considered to be limiting of its scope, the subject matter of the present application will be described and explained with additional specificity and detail through the use of the accompanying drawings, in which:

FIG. 1 is a schematic block diagram of an automated door system with a first door control module and a second door control module, in accordance with various embodiments;

FIG. 2 is a schematic block diagram of an automated door system with a first door control module, a second door control module, and a third door control module, in accordance with various embodiments;

FIG. 3 is a schematic block diagram of an automated door system with a first door control module, a second door control module, a third door control module, and a server 140, in accordance with various embodiments;

FIG. 4 is a schematic block diagram of an automated door system showing a wireless proximity region, in accordance with various embodiments;

FIG. 5 is a schematic flow chart diagram of a method of controlling a powered door, in accordance with various embodiments;

FIGS. 6A and 6B are schematic block diagrams of automated door systems having multiple antennas, in accordance with various embodiments;

FIGS. 7A and 7B are schematic block diagrams of automated door systems having a smart door button, in accordance with various embodiments;

FIGS. 8A, 8B, and 8C are schematic block diagrams of an automated door system configured to leverage internet-connected mobile devices as a gateway to the cloud, in accordance with various embodiments;

FIGS. 9A, 9B, and 9C are schematic block diagrams of an automated door system configured to update hardware functionality, in accordance with various embodiments;

FIG. 10 is a schematic block diagram of a door calibration for an automated door system, in accordance with various embodiments;

FIGS. 11A, 11B, and 11C are schematic block diagram for setting and/or calibrating opening distance for an automated door system, in accordance with various embodiments;

FIG. 12 is a schematic block diagram of an automated door system having configurable inputs and/or outputs, in accordance with various embodiments;

FIGS. 13A and 13B are schematic block diagrams of an automated door system configured for mobile device optimization, in accordance with various embodiments;

FIG. 14 is an exemplary table showing different properties of different types/models of mobile devices, in accordance with various embodiments;

FIGS. 15A, 15B, and 15C are schematic block diagrams of various operating modes of an automated door system, in accordance with various embodiments; and

FIG. 16 is a schematic block diagram of a method for reducing latency of an automated door system response, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein without departing from the spirit and scope of the disclosure. Thus, the detailed description herein is presented for purposes of illustration only and not of limitation.

As used herein, the terms “including,” “comprising,” “having,” and variations thereof mean “including but not limited to” unless expressly specified otherwise. Accordingly, the terms “including,” “comprising,” “having,” and variations thereof are intended to cover a non-exclusive inclusion, such that a process, method, article, or apparatus that comprises a list of elements does not include only those elements but may include other elements not expressly listed or inherent to such process, method, article, or apparatus. An enumerated listing of items does not imply that any or all of the items are mutually exclusive and/or mutually inclusive, unless expressly specified otherwise.

Further, in the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Thus, when a particular feature, structure, or characteristic is described in connection with an embodiment, it is submitted that it is within the knowledge of one skilled in the art to affect such feature, structure, or characteristic in connection with other embodiments whether or not explicitly described. Similarly, the use of the term “implementation” means an implementation having a particular feature, structure, or characteristic described in connection with one or more embodiments of the present disclosure. Absent an express correlation to indicate otherwise, an implementation may be associated with one or more embodiments. After reading the description, it will be apparent to one skilled in the relevant art(s) how to implement the disclosure in alternative embodiments.

In various embodiments, an automated door system is provided herein. Generally, the disclosed automated door system has various benefits that overcome various shortcomings of conventional doors, according to various embodiments. The automated door system may provide improved automation, autonomy, and/or connectivity features when compared to conventional doors. For example, the automated door system may provide access control (e.g., locking and unlocking), assisted/automated door opening/closing actuations, remote monitoring, and/or occupancy/usage analytics, among other features. In various embodiments, the automated door system may automate locking/unlocking of a door and/or may automate opening/closing of the door based on various factors, such as triggering events and/or proximity events, as described in greater detail below. Thus, the automated door system may improve door access and functionality for human users, vehicles, drones, robots, and animals, among other users, and may provide for usage tracking and/or data collection, according to various embodiments.

As used herein, the term “actuation” and the like (e.g., actuating, actuated, etc.), when used in connection with functionality of a powered door, may refer to locking, unlocking, opening, or closing the door. Also, the term “detecting” and the like (detection, detected, etc.), when used in connection with functionality of a powered door, may refer to tracking, sensing, monitoring, determining, identifying, or otherwise perceiving events around or relative to the powered door. For example, as described herein, various triggering events or proximity events may be ‘detected’ by the automated door system, and in response to the detection, the automated door system may be configured to perform an ‘actuation.’

Continuing the examples, the disclosed automated door system may be configured to automatically open and close a powered door in response to specific users' proximity to the powered door. “Closing” the powered door may be an active/powered step or “closing” the powered door may be a passive step. That is, closing the powered door may refer to ceasing to hold the door open and allowing the door to close on its own (e.g., the door may be biased such that the door may close in the absence of an opening force). In various embodiments, “closing” the door may comprise actuating a relay within the actuation assembly of the powered door.

In various embodiments, the automated door system is not an automated system for opening powered doors for every person that passes through the door, but instead provides personal, hands-free actuation of powered doors for individual users. In various embodiments, the automated door system enables users, such as those with disabilities, to transport themselves to different places in their daily route without relying on others for assistance to gain entrance to and exit from buildings and without necessarily requiring physical/mechanical actuation of a button, thereby increasing feelings of empowerment and independence. While specific attention and emphasis may be placed upon users with disabilities and/or upon opening and closing actuations, it is expected that other types of users may benefit from the automated door system disclosed herein and that other types of actuations (e.g., locking and unlocking) may be accomplished by the automated door system. For example, elderly users, parents with small children (e.g., pushing a stroller), cargo services, delivery services, vehicles, robotic vehicles, drones, visitors, maintenance workers, and injured persons, etc., may benefit from the disclosed automated door system.

In various embodiments, the automated door system includes a first door control module configured to be mounted to a powered door. The first door control module may comprise a processor configured to communicate with a tangible, non-transitory memory having instructions stored thereon that, in response to execution by the processor, cause the automated door system to perform at least one actuation of the powered door. In various embodiments, the automated door system may further include one or more antennas and/or one or more detectors or sensors that are configured to detect and determine a triggering event or a proximity event relative to the powered door, and the at least one actuation performed by the automated door system may be performed in response to the triggering event or the proximity event, as described in greater detail below. Each of these antennas, detectors, and/or sensors may have one or more processors, and the configuration and functionality of the system described herein may be processed by various processors of the various components of the system. Indeed, when the processor of the first control module is described herein, or when functionality of the first control module is referenced here, that actual computing/processing may be performed on one or more processors of the peripheral antennas and/or detectors. Further, as described in greater detail below, the system may include or may be configured to be in electronic communication with one or more user devices (e.g., smartphones, etc) and/or one or more servers, and various functionality may be carried out by respective processors of these components.

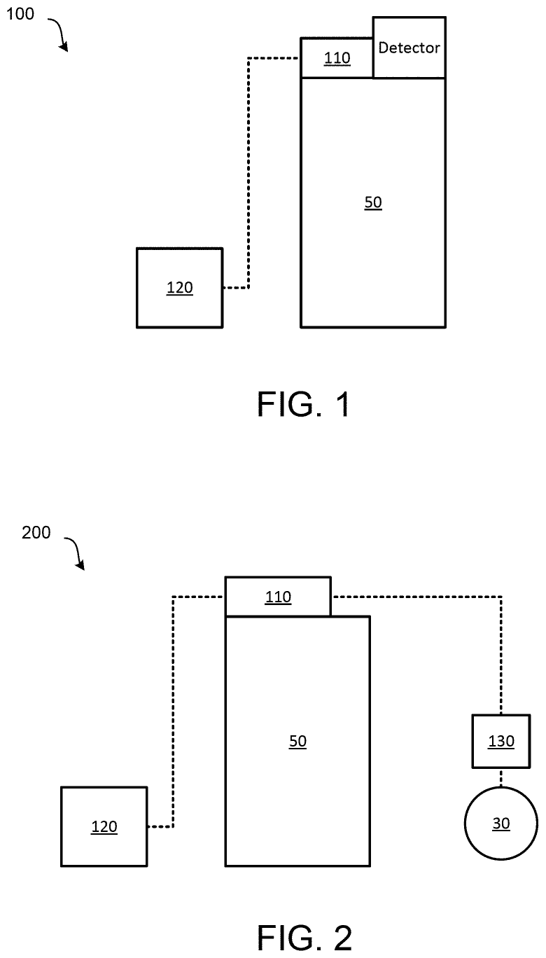

In various embodiments, and with reference to FIG. 1, the automated door system 100 may include a first door control module 110 and a second door control module 120. Generally, the first door control module 110 is a fixed control unit and the second door control module 120 is a portable/movable control unit that moves with the user to interface with different first door control modules of different doors. Accordingly, the first door control module 110 may be mounted in a fixed position relative to a powered door 50 and the second door control module 120 may be carried by a user and may be configured to be in electronic communication with the first door control module 110.

In various embodiments, a wireless electronic connection between the first door control module 110 and the second door control module 120 enables automated control of the powered door 50. For example, the system 100 may be configured such that the first door control module 110 causes the powered door 50 to lock, unlock, open, and/or close based on the proximity of the second door control module 120 to the first door control module 110. As described in greater detail below, the proximity may be determined via wireless communication between the first door control module and the second door control module. In various embodiments, the automated door system includes a sensor configured detect a position, a movement, a trajectory, or other property of a user relative to the powered door 50.

In various embodiments, the first door control module 110 may include hardware that controls or facilitates control of the powered door 50. The first door control module 110 may be an add-on or a retro-fit install that interfaces with an existing motor for a powered door 50, or the first door control module 110 may be integrated with a motor/actuation assembly for a powered door 50. In various embodiments, the first door control module 110 is configured to control locking/unlocking of the powered door 50, or is configured to interface with a locking mechanism. Thus, the term “powered door” as used herein does not necessarily require a door that is able to perform a powered opening or closing, but the term “powered door” may simply refer to a door that has an access control mechanism (e.g., a locking/unlocking mechanism), according to various embodiments.

The first door control module 110 may be a computer/controller with a processor and a tangible, non-transitory memory for storing code and/or instructions thereon. The second door control module 120 may include specific/unique device, such as a fob or other electronic device specifically configured to communicate with the first door control module 110 to automate the powered doors 50. The second door control module 120 may be integrated into an accessibility device, such as a wheel chair, a crutch, a scooter, slings, boots, casts, etc. In various embodiments, the second door control module 120 may comprise an application (e.g., an “App”) on a portable electronic device of a user. That is, the second door control module 120 may be a downloadable app on a smartphone, tablet, or other portable computing device. Accordingly, the app may utilize one or more of the components of the portable electronic device of the user to communicate with the first door control module 110. That is, the processor, memory, wireless communication antennas, etc., of the portable electronic device may be utilized by an app in order to achieve automated door opening and closing, as described in greater detail below.

Functionality of the overall system 100 may be accomplished via computer processor execution by one or both of the first door control module 110 and the second door control module 120. That is, the control modules 110, 120 may include one or more processors and one or more tangible, non-transitory memories configured to implement digital or programmatic logic. For example, the hardware of the first door control module 110 may comprise computer-based system program instructions and/or processor instructions, which may be loaded onto a tangible, non-transitory computer readable medium having instructions stored thereon that, in response to execution by a processor, cause the processor to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media that were found in In re Nuijten to fall outside the scope of patentable subject matter under 35 U.S.C. § 101.

In various embodiments, for example, the one or more processors of the door control modules 110, 120 may comprise one or more of an application specific integrated circuit (ASIC), digital signal processor (DSP), field programmable gate array (FPGA), general purpose processor, and/or other programmable logic device, discrete gate, transistor logic, or discrete hardware components, or any various combinations thereof and/or the like, and the one or more tangible, non-transitory memories store instructions that are implemented by the one or more processors for performing various functions, such as the systems and methods of the inventive arrangements described herein.

The automated door system may perform an automated actuation based on various factors. For example, the automated door system may include one or more sensors or detectors that are configured to detect position, movement, trajectory, or other parameters of a user (e.g., human or non-human) relative to the powered door. In various embodiments, the automated door system may perform the actuation in response to analyzing a wireless connection (e.g., measuring signal strength) between the first door control module and the second door control module. The automated door system may utilize only sensors/detectors to detect a triggering/proximity event, may utilize only wireless connection analysis to detect a triggering/proximity event, or may utilize both sensors/detectors in conjunction with wireless connection analysis.

In various embodiments, users may enroll to have access to the system 100. That is, a prospective user may sign-up on a website or over the phone to have a fob or other independent electronic device sent to them for interfacing with the first door control module 110 installed on powered doors 50. The users may register their wheelchair other accessibility device having integrated components that allow it to interface with the first door control module 110. In various embodiments, anyone may become a user by downloading an app onto their portable electronic device. During operation, the first door control module 110 may check to see if the second door control module 120 is registered/enrolled in a server/cloud database before opening/closing the powered door 50.

In various embodiments, the automated door system is configured to track and/or monitor these parameters over time (e.g., over multiple interactions with powered doors). That is, the automated door system may be configured to analyze previous/historical interactions of a specific user with powered doors. The historical interaction data may be stored on a local memory, and/or may be transmitted to a server/cloud database. This historical interaction data may be utilized to determine user intent, thus improving the ability of the automated door system to accurately detect intentional ingress/egress through the powered door and to avoid false positives and false negatives. For example, instead of the automated door system only performing an actuation in response to a threshold parameter (e.g., a triggering or proximity event) being met, the automated door system may be configured to calculate or predict future movement of the user, and thus determine a time of arrival. Accordingly, the automated door system may be configured to perform an actuation in response to calculated or predicted arrival times. The determination/calculation of the predicted arrival time may be based on detected presence/proximity data, signal strength analysis, historical interaction data, and/or manually entered user preference data (as opposed to simply a threshold proximity).

Said differently, the automated door system may be configured to calibrate and/or adjust the actuations based on tracked historical interaction data. This historical interaction data may be utilized by the automated door system to calibrate and adjust a actuation properties for a specific user and/or a specific door. For example, if the automated door system determines a specific user is historically pausing before entering powered doors, the automated door system may adjust/calibrate the profile/account settings of the specific user to perform the actuation earlier (e.g., initiate an opening actuation sooner). Similarly, if the automated door system detects that multiple or many users are historically pausing before entering a specific powered door, the system may adjust/calibrate the settings of the specific door such that the specific door performs the actuation earlier.

In various embodiments, the wireless electronic connection between the first door control module 110 and the second door control module 120 is short-range radio signals, such as Bluetooth technology. For example, the first door control module 110 may include an integrated computer and one or more wireless radio antennas, such as a 2.4 GHz Bluetooth antenna. The second door control module 120, which may be a fob, embedded wheelchair device, or smartphone app, among others, may transmit a signal which can be detected by the antenna of the first door control module 110, thereby wireless electronically connecting the two modules 110, 120 together (as used herein, the terms “Bluetooth network” or “Bluetooth Low Energy network” refers to the modules 110, 120 wirelessly interconnected via short-range radio signals). In various embodiments, the first door control module 110 may function as a beacon that emits a Bluetooth signal that is detected by corresponding antenna(s) of the second door control module 120. In various embodiments, a directional antenna may be used such that signals are emitted in desired directions, thus improving the precision of the system and improving the accuracy of the calculated/determined proximity of the user relative to the powered door. While various different wireless connection technologies may be utilized to electronically connect the two modules 110, 120, Bluetooth technology, especially Bluetooth “Low Energy” (“BLE”) technology, may be especially useful in the system 100 disclosed herein. BLE is a personal area network that provides considerably reduced power consumption while maintaining similar communication range as standard Bluetooth. In various embodiments, the system may utilize an Ultra-Wide Band (UWB) signal and/or BLE technology for determining proximity of the user to the powered door.

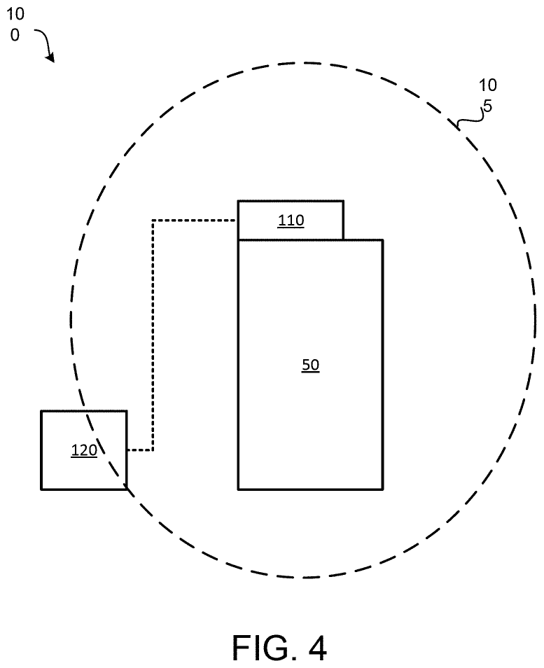

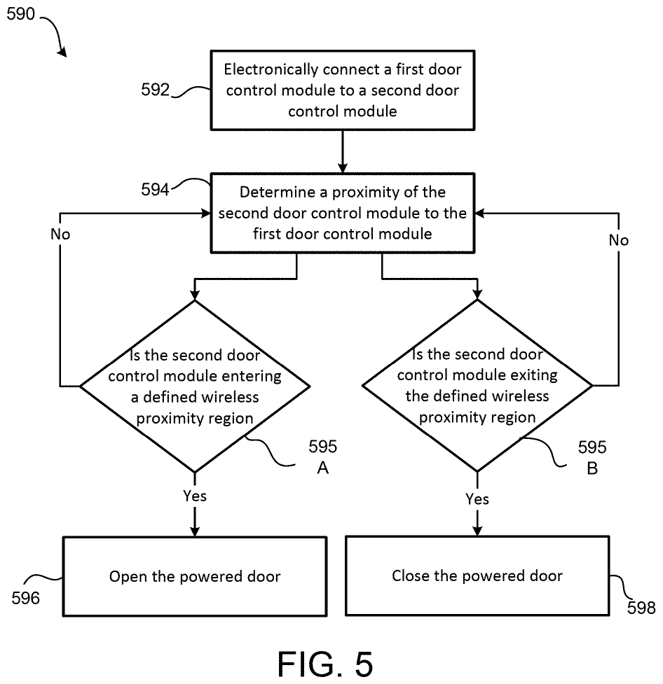

In various embodiments, and with momentary reference to FIG. 4, the first door control module 110 may emit/define a wireless proximity region 105. The wireless proximity region 105 may represent a predetermined area around the powered door 50 that is used to determine when to actuate an opening actuation or a closing actuation of the powered door 50. That is, as described in greater detail below with reference to the method 590 of FIG. 5, wireless proximity region comprises a threshold distance from the powered door 50, and when the user (e.g., the second door control module 120) passes said threshold, the powered door 50 is actuated. Accordingly, in response to the second door control module 120 entering the wireless proximity region 105, the processor(s) of the system 100, such as the hardware processor of the first door control module 110, may cause the powered door 50 to open (e.g., may cause the door motor and corresponding actuation assembly to perform an opening actuation). As long as the user remains within the wireless proximity region 105, the powered door 50 may remain open. In response to the second door control module 120 exiting the wireless proximity region 105, the processor(s) of the system 100, such as the hardware processor of the first door control module 110, may cause the powered door 50 to close (e.g., may cause the door motor and corresponding actuation assembly to perform a closing actuation). In various embodiments, once a connection between the first and second door control modules 110, 120 is established, the modules 110, 120 will ascertain the distance, velocity, and direction of the user to determine if the user's intention is to access the door.

In various embodiments, determining whether the second door control module 120 is within or beyond the wireless proximity region is performed via a signal strength analysis. That is, a measurement of the power present in a received radio signal may be used to determine a proximity of the user (e.g., the second door control module 120) relative to the powered door 50 (e.g., the first door control module 110). For example, the first door control module 110 may include code running on the processor/computer that not only validates that the second door control module is a registered/activated/approved user, but a signal strength analysis may be performed to determine the proximity of the user, thereby enabling the system 100 to open the powered door 50 as the user is approaching the powered door 50. As mentioned above, the wireless connection and/or signal strength analysis may be an alternative to or in addition to one or more sensors for detecting physical movement of a user relative to the powered door. For example, the system may utilize cameras, radar detectors, lidar detectors, infrared sensors, microwave sensors, motion sensors, and/or other types of machine-perception sensors to determine a presence, trajectory, location, or position of a user relative to the powered door. This ‘presence’ data, optionally together with signal strength information and/or contextual information such as time of day, user preferences, access rights, etc., may be used to determine, by the processor, if and when to actuate the powered door. In various embodiments, the system may include one or more environmental sensors, or may be configured to receive data from external environmental sensors, such as external temperature, wind, or weather data, and may utilize this environmental and/or contextual data to adjust actuation(s) and/or calibrate actuation(s). For example, on windy days, the powered door may encounter increased or decreased resistance to opening/closing actuations, and the automated door system may be configured to adjust/calibrate its actuations accordingly.

In various embodiments, the term “antenna” refers to a device that is configured to facilitate wireless communication between the first door control module and the second door control module. That is, the term antenna refers to a ‘communication’ connection (e.g., data transfer capabilities) between the first door control module and the second door control module, according to various embodiments. Accordingly, the system may include one or more antennas that, in addition to functioning as a communication means between the first door control module and the second door control module, also function as proximity sensors (e.g., via a signal strength analysis). Alternatively, the system may include one or more detectors (without a communication pathway), and the detected presence data may be utilized by the system to trigger door actuations and calibrations. In other embodiments, the system includes both one or more antennas and one or more detectors.

In various embodiments, the system is configured to perform various calibrations to improve the accuracy of the signal strength analysis for determining the proximity of the user to the powered door. The calibrations may be performed using the first door control module 110 and/or the second door control module 120. In various embodiments, the calibrations may be performed based on user data. For example, the system may determine if the user is generally pausing/waiting before entering powered doors (e.g., see the discuss above regarding historical interaction data), which may be an indication that powered doors are not opening sufficiently by the time the user arrives at the entry, and thus the system may adjust the proximity settings so that the powered doors initiate opening sooner or open faster, etc. Accordingly, the automated door opening may be customized for specific users based on the speed of their movement, the type of phone they have (e.g., signal strength, antenna considerations), etc. In various embodiments, these user specific calibrations may be input manually via the second door control module 120 (e.g., via an application on the portable electronic device of a user) such that the user can enter feedback regarding operation of the powered door, and the manually entered feedback can be used in the calibration.

In various embodiments, and with reference to FIG. 2, the automated door system 200 may further include a third door control module 130. The third door control module 130 may be mounted in a fixed position relative to the powered door 50, similar to the first door control module 110, and the third door control module 130 may be coupled in electronic communication to a button 30 that is depressible for manual control of opening/closing of the powered door 50. That is, the third door control module 130 may be coupled to an existing button 30 (or may integrated/embedded into a button) and may be configured to be in wireless electronic communication with one or both of the other door control modules 110, 120. In such embodiments, the system 200 is configured to work with a conventional handicap door button will still work as normal with the support circuitry. In various embodiments, the second door control module 120 (e.g., the portable, user device) may interface directly with the third door control module 130, which may in turn communicate with the powered door 50 via the first door control module 110.

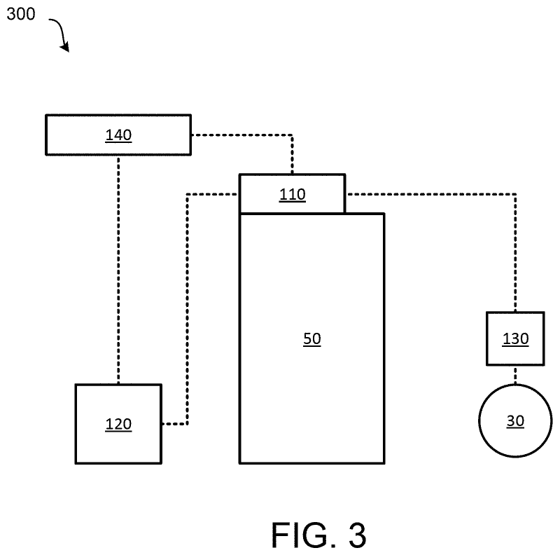

In various embodiments, and with reference to FIG. 3, the automated door system 300 may further include a server 140 (e.g., may be in electronic communication with the cloud). In various embodiments, the server 140 may be coupled in wireless electronic communication via the server 140 via a mobile broadband network. The mobile broadband network may be established via an antenna of the first door control module 110, and/or the mobile broadband network may be established via a data/cellular connection of a portable electronic device of the user. Accordingly, the various modules 110, 120, 130 may interface with each other via a short-range network, such as a Bluetooth Low Energy network, and the modules 110, 120, 130 may interface with the server 140 via a mobile broadband network of at least one of the modules 110, 120, 130.

Data indicative of and pertaining to the status, condition, and/or general operation of the powered door 50 may be transmitted to the server 140 to be stored, analyzed, and/or further utilized. For example, information pertaining to the number of door openings at a specific door or at a specific property, door openings per user, time a door is open vs time door is closed, etc., may be collected by the system 300 and transmitted to the server 140. In various embodiments, such data may be stored locally on the tangible, non-transitory memories of the various modules 110, 120, 130 and may be used to perform imminent calculations and to make urgent determinations, such as when to open and close the powered door 50. This collected data stored on the server may be useful to owners, manufacturers, installers, and/or service providers, as they may proactively maintain their automated door entryways. For example, the system 300 may be able to send diagnostic information to those involved in the handicap door maintenance.

Diagnostics may include a building-wide/facility wide map of the locations of power/assisted doors, battery life of the button, speed and force of doors, counters for a door's usage, malfunctioning motors, malfunctioning buttons, malfunctioning transmitters, location heat map of door foot traffic, etc. This collected information (e.g., the diagnostic information) may be transmitted to interested and involved persons via email, text, app notification, and work orders (if needed) can be sent to maintenance personnel. The diagnostics information can be sent immediately to the cloud service or can be saved locally to the device and be sent at set intervals of 30 min, 1 hour, 24 hours, etc. In various embodiments, diagnostic data is collected from user input via the second door control module 120. That is, a user may provide feedback pertaining to the operation of the powered door 50 and/or other feedback pertaining to the entry way (e.g., the presence of ice or other potentially unsafe conditions), or general feedback pertaining to the property/facility.

In various embodiments, and with reference to FIG. 5, a method 590 of controlling a powered door 50 is provided. The method 590 includes electronically connecting a first door control module to a second door control module at step 592 and determining a proximity of the second door control module to the first door control module at step 594, according to various embodiments. The connection formed during step 592 may be a wireless connection, such as via BLE. As mentioned above, the first door control module may include hardware and processor(s) fixed relative to the powered door and the second door control module may include a portable device, such as a portable electronic device (e.g., smartphone) of a user with an application stored thereon. Steps 592 and 594 may be performed by the one or more processor(s) of the modules of the system. Step 594 may include performing signal-strength analyses to determine the proximity, as described in greater detail below.

In various embodiments, the proximity of the second door control module determined during step 594 may be used to determine further operations of the system. That is, as shown in decision block 595A of the schematic depiction of the method 590 in FIG. 5, if the second door control module is entering a defined wireless proximity region, the processor actuates the powered door to open the powered door at step 596 as the user is advancing towards it. Also as shown in FIG. 5, decision block 595B of the schematic depiction shows how, if the second door control module is exiting the defined wireless proximity region, the processor actuates the powered door to close the powered door at step 598 after the user has passed through the door and is moving away from it.

In various embodiments, the method 590 may further include determining, by at least one of the portable electronic device and the processor, a position, an orientation, and/or a location of the portable electronic device relative to the user. This information may be detected/determined by receiving sensed information form an accelerometer, magnetometer, and/or a light sensor, among other sensors, of the portable electronic device. The information received from these sensors may be useful in determining the position, orientation, and/or location of the portable electronic device, which in turn may affect the signal-strength calculations that are performed to determine the proximity of the user to the powered door. That is, the location of the portable electronic device relative to the user as the user is approaching the door (e.g., whether the portable electronic device is in the user's hand, is in the user's pocket, or is in the user's bag, etc.) may affect the signal-strength analysis of step 594. Accordingly, the detected information pertaining to the position, orientation, location of the portable electronic device, as well as the manufacturer/model and/or type of portable electronic device, may help calibrate operation of the system, as mentioned above, and may help the system to improve/optimize the opening actuation and the closing actuation.

In various embodiments, the method 590 may include providing, by at least one of the first door control module 110 and the second door control module 120 (e.g., by at least one of the portable electronic device and the processor), an audible indicator, a visible indicator, and/or a haptic indicator to the user pertaining to the status of the powered door. That is, the method 590 may include providing sensory feedback to the user to indicate whether or not the door is open or closed. For example, the method 590 may include providing audible feedback to a blind user that the door is open to facilitate and guide the blind user's entry through the door. In various embodiments, the method 590 may further include receiving, by the processor, feedback from the user via the application on the portable electronic device of the second door control module, wherein the user feedback pertains to a status/condition of the door and/or a status of the property/facility, etc.

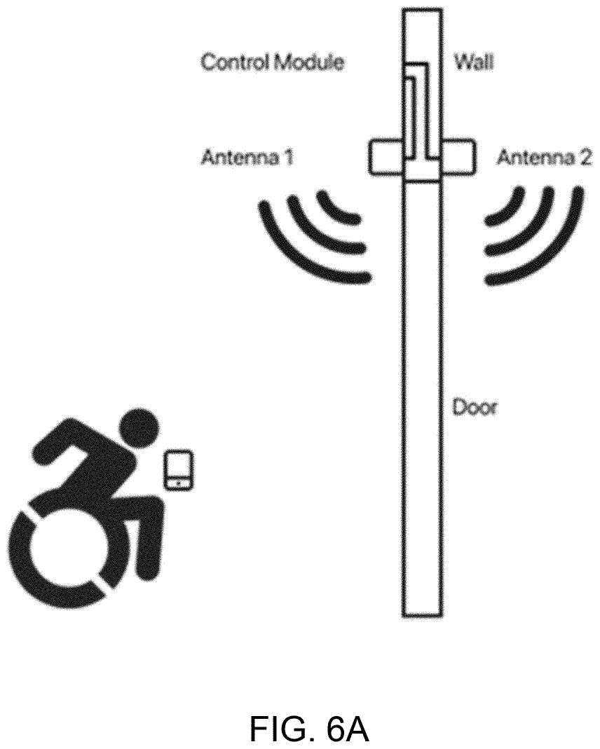

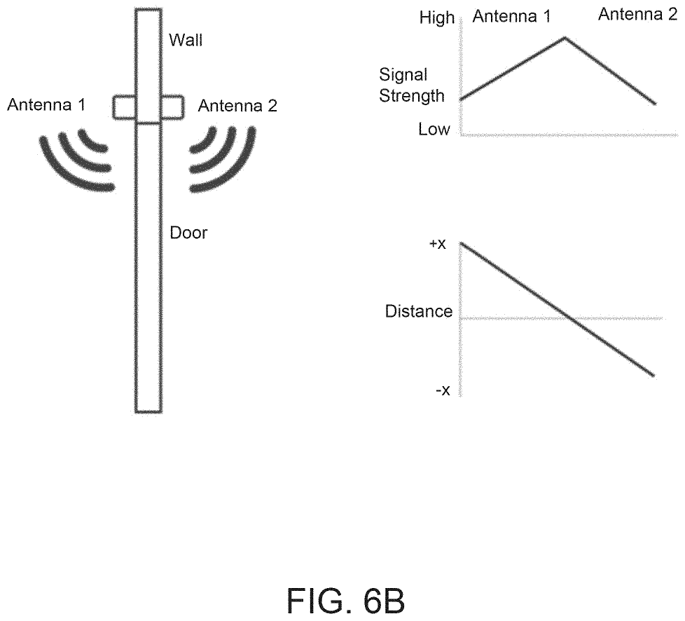

In various embodiments, and with reference to FIGS. 6A and 6B, an automated door system may include multiple antennas. For example, wireless signals (e.g., wireless radio signals, such as Bluetooth) can be obstructed by door and/or building materials. Thus, when using devices installed on door entrances there may be metal, brick, wood, glass, UV-tinted glass, glass filled with argon gas, or other materials, and the materials may attenuate wireless signals as they travel therethrough. For circumstances where a signal is required to be fairly uniform on both sides of an object, like a door, the signal strength may be reduced if a single antenna is employed. In various embodiments, a fixed hardware device is performing an action based on the proximity of a mobile device to the door. In various embodiments, if the fixed hardware device only has 1 antenna, the proximity action for both sides of the door will not be uniform. Thus, a compromise is often warranted to account for the attenuation of the door and threshold which leads to an undesirable setting. Further, there may be situations where it is important to know what side of the door someone is on or whether they are entering or exiting through the entryway.

Accordingly, using two or more antennas mounted to a two-sided object, like above a door, may provide for signals that have unobstructed line of sight to the user and/or the mobile device carried by the user, regardless of what side of the door the user is on. Using two or more antennas allows the installation to not be affected by the material of the door or the surrounding threshold or building material. It allows for actions to be taken on each side based on proximity where the proximity distance can be unique for each individual side along with different actions that can be taken for each side, according to various embodiments.

As used herein, the term “antenna” may refer to a device configured to transmit or receive signals, such as radio signals or other types of electromagnetic radiation. Further, the term “antenna” may refer to a single antenna device, or may refer to an antenna array or may refer to multiple antennas rods, wires, or other segments. Accordingly, in various embodiments, the system having two antennas, one on each side of a door, may refer to one or more antennas/antenna arrays on each side of the door.

From the difference in signal strength between the two or more antennas, the fixed hardware device can determine if the mobile device is egressing or ingressing. This is valuable because, in the situation where the fixed hardware device is connected to electrified locks, it can unlock the door and provide free egress, according to various embodiments. It may also be valuable for the facility to know if people are entering or leaving the building. It could be used to approximate the occupancy of a room or building. Because the antennas are able to determine which side the person is on it can also help in access control situations where a locking or unlocking action may be taken based on which side of the door the person is on.

Further, using two or more antennas may provide more accurate distancing approximation. Said differently, with two data points from the two antennas, the accuracy and reliability of the proximity determination may be augmented. For example, there may be a data point that is direct and includes reflections of the environment of the mobile device as well as an attenuated data point which will not include as much signal reflection. Because there is data being collected from 2 different environments (each side of the door), this can help in creating a more accurate distancing algorithm that can overcome some of the difficulties working with radio frequency signal strength, according to various embodiments. Thus, the automated door system may be configured to receive wireless communication data from a first antenna on a first side of a powered door and from a second antenna on a second side of the powered door. The automated door system (e.g., the processor of the first door control module) may compare the signal strength data from the two antennas in order to adjust the actuation of the powered door (e.g., adjust timing of the actuation). Said differently, the operations performed by one or more controllers of the system may include determining an extent of reflective signal noise (e.g., on the side of the door where the user is located) and calibrating or adjusting timing and accuracy of the at least one actuation of the powered door accordingly.

Using multiple antennas such as an antenna array may allow for the fixed hardware device to determine the “angle of arrival” of wireless signals coming from the mobile device. The “angle of arrival” can be used to increase the accuracy of positioning the mobile device to the fixed hardware device by understanding the angle between the two devices. This information can provide similar benefits as understanding the direction at which someone is passing through a door, such as tracking whether or not the mobile device is egressing or ingressing, but with even greater accuracy than simply measuring the difference in 2 or more antennas. By using angle of arrival techniques which utilize phase difference, the system can observe the change in angle over time in order to understand the movement of the mobile device around an entrance. Further, the automated door system may also have presence sensors including, but not limited to, ultrasonic, infrared, laser, etc. to augment the system's ability to accurately and reliably determine egress or ingress, proximity, distance, etc. Each of the antenna's may include its own control module having respective processors, or the processor(s) of the first door control module may perform the processing, with the antennas connected via wireless or wired connection to the first door control module. That is, in various embodiments the automated door system includes multiple parts, such as 2 or more antennas or sensors and a central hub (i.e., the first door control module). In various embodiments, the first door control module may be configured to be in electrical communication with other electronic control modules of the powered door, such as motors for opening and closing the door, access control panels, door locking mechanisms, door hardware/systems, and/or building hardware/systems.

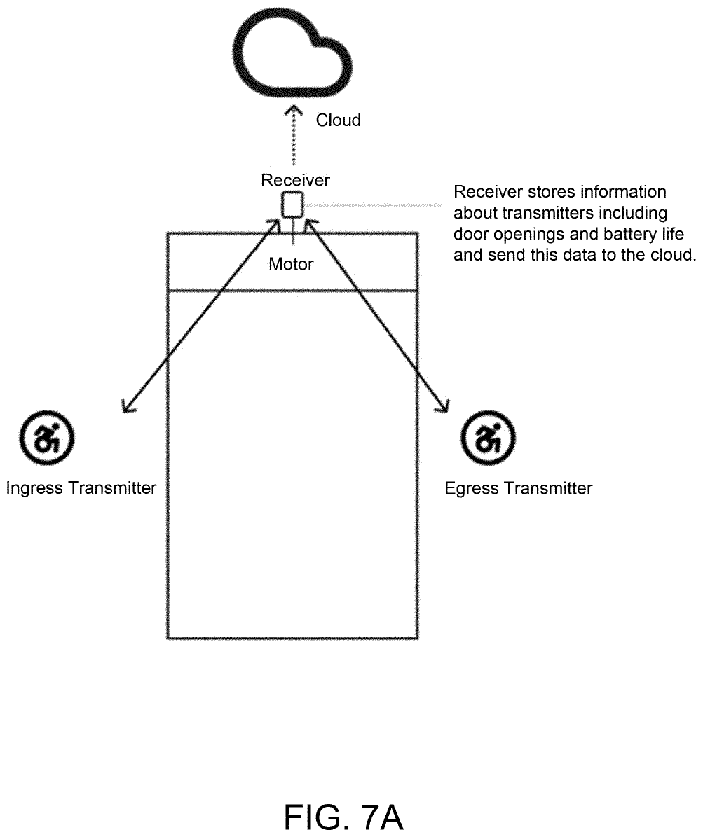

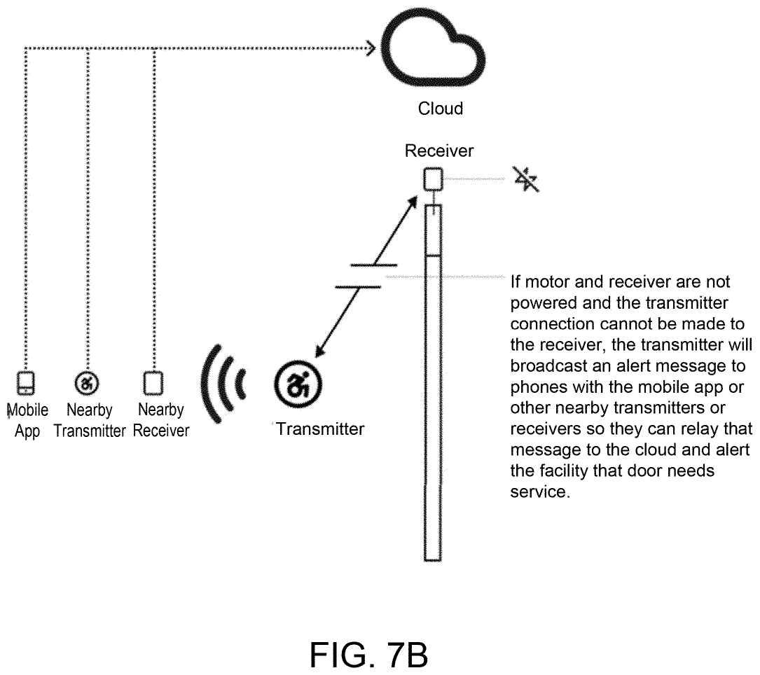

In various embodiments, and with reference to FIGS. 7A and 7B, an automated door system having a “smart” door button is provided. For example, facilities may include push-plate buttons and automatic motors to provide accessible entrances for building users. For conventional door systems, there is no way of knowing how many times a button is pressed or how many times the motor is cycled. If the push-plate button uses a wireless transmitter, they have no way of knowing the battery life. Without this information, they rely on preventive maintenance schedules or complaints to know if push-plate buttons are not working. This wastes time and money and when doors are not in service for users this can lead to bad user experiences and/or ADA lawsuits. Further, conventional button transmitters and receivers may not collect usage analytics and also have no networking to enable them to share that information with building managers. Signal attenuation between the button and motor can prevent the signal from being properly transmitted and require the user to push the button multiple times. Door motors may be turned off after hours or by users for one reason or another. Building managers and users may be unaware that a motor is turned off. This effectively renders the door out of service because the buttons will no longer actuate door opening. When the door motor is turned off, building managers and users are generally unaware because there is no identifying feature to let them know. If the motor is turned off, it is not expected that the user will troubleshoot and turn the motor back on.

Disclosed herein, according to various embodiments, is a smart door button that addresses one or more of the aforementioned shortcomings pertaining to conventional door buttons. In various embodiments, the door button includes a sophisticated communication protocol (e.g., Bluetooth Low Energy, among others) to provide greater functionality. The receiver may be fixed to the door motor and connected to power and the motor's actuation control. In a situation where the accompanying transmitters are not being used, the receiver can receive the existing button actuator contacts as inputs, monitor those inputs, and output a signal when the buttons are pressed, in order to open the door and still be able to count how many times buttons are being pressed.

In various embodiments, the receiver uses a networking protocol (i.e. BLE, Wi-Fi, LTE, etc.) to send data to the cloud. The accompanying transmitters can be securely paired to the receiver. When they are pressed, they may send a signal to the receiver to perform an action (e.g., lock, unlock, close, or open the door). The receiver may store a corresponding message and along with its date and time and will send that data to the cloud. Facility managers and other stakeholders can now know how many times the buttons are being pressed. Because the buttons can be labeled as ingress or egress buttons, the facility manager will know how many times the ingress button is used to enter and how many times the egress button is used to exit which can help them understand things like foot traffic.

In various embodiments, the transmitter sends its battery level to the receiver which will also send that data to the cloud. This will inform facility managers and other stakeholders when batteries need replaced. Knowing how many times the door motor is cycled will be helpful to understand when the door motor may need to be repaired and this data could be shared with motor OEMs for them to understand how their products are being used by customers along with understanding their overall operation over the motor's lifespan. The receiver may be configured to confirm that it has received the transmitter messages. In the situation where the message is not received because of a signal issue, the transmitter can proactively resend the message. This prevents users from having to push the button multiple times when the message fails to be received by the receiver. In various embodiments, the button transmitter can be powered by a battery or other electoral energy storage device, may be powered via a wired connection to the building's power, and/or the action of the button or switch being mechanically depressed/actuated may generate electrical energy (e.g., via one or more electrical generating mechanisms) to power the transmitter.

When the motor is turned off, the receiver may no longer have power. When the transmitter attempts to connect and is inevitably unable to when the receiver is no longer powered, it will know that the receiver does not have power which indicates that the motor has lost power, or that the receiver was unplugged. In either case, the buttons will not function to open the door which is a cause for the building manager to perform maintenance. Because the transmitters may be battery-powered they will continue to function even when the door motor is no longer powered, and they can advertise this issue as soon as they become aware. Because they may not have communication with the receiver they are paired to, transmitters will advertise this message/alert to other devices in the ecosystem which may include mobile phone users, other receivers or other transmitters.

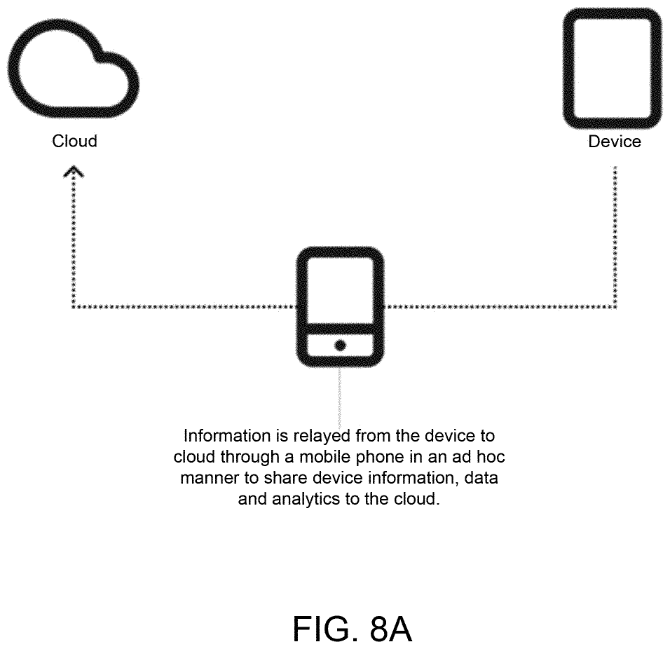

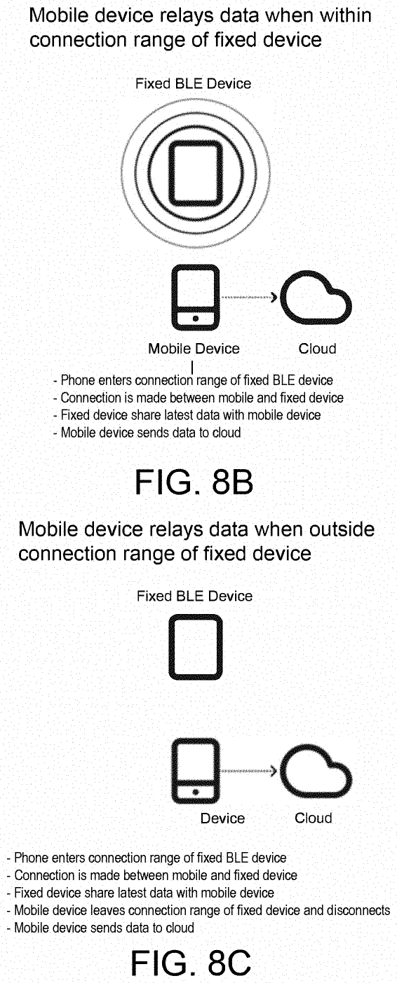

In various embodiments, and with reference to FIGS. 8A, 8B, and 8C, an automated door system may be configured to leverage internet-connected mobile devices as a gateway to the cloud/server. Said differently, the presently disclosure may provide a method of crowdsourcing network access via ad hoc short-range wireless connections. An inseparable and inherent problem with conventional door components is connecting them to a network. Traditional methods include Wi-Fi, Ethernet, and LTE. Wi-Fi can be difficult where the signal from a router is unavailable. It is also generally power-intensive which can be a drawback for battery-powered devices. Ethernet can be difficult because it requires a wired connection and wiring may be infeasible or inconvenient. LTE requires a data plan and its cost may not be viable. LTE also requires that service is available in a particular region where the connected device must transmit data. Further, devices that are connected to the building's network via Wi-Fi or Ethernet constitute a node for the network and may introduce vulnerabilities to the network. Methods like this generally require involvement with IT department stakeholders which may delay integration or sale of such products.

Accordingly, the present disclosure provides various systems, functionality, and features to facilitate connecting the hardware of an automated door system to the cloud (e.g., a server) via connections made by mobile phone devices of users who are a part of the products' ecosystem. This allows the device to communicate to the cloud without the need for traditional methods. Mobile phones already contain networking like LTE and Wi-Fi and are generally connected via one protocol or the other. Their operating systems can also handle potential network security vulnerabilities. They also have memory that can retain the information until network connectivity is available.

Devices that are a part of the same product ecosystem as the mobile phone (i.e. accompanying smartphone app) are able to make ad hoc connections in order to send data to the cloud using short-range communication protocols like Bluetooth Low Energy, or other protocols. By using the mobile phone as a method of sending data to the cloud, this eliminates the need for the device which the mobile phone interacts with to have a connection to the cloud itself because the data can be relayed from the device to the mobile phone and then to the cloud on an ad hoc basis. Because protocols like Bluetooth Low Energy do not require pairing, devices can send information to a user's mobile phone while they are temporarily in range of the device and the mobile phone can send that information to the cloud without any action required from the user.

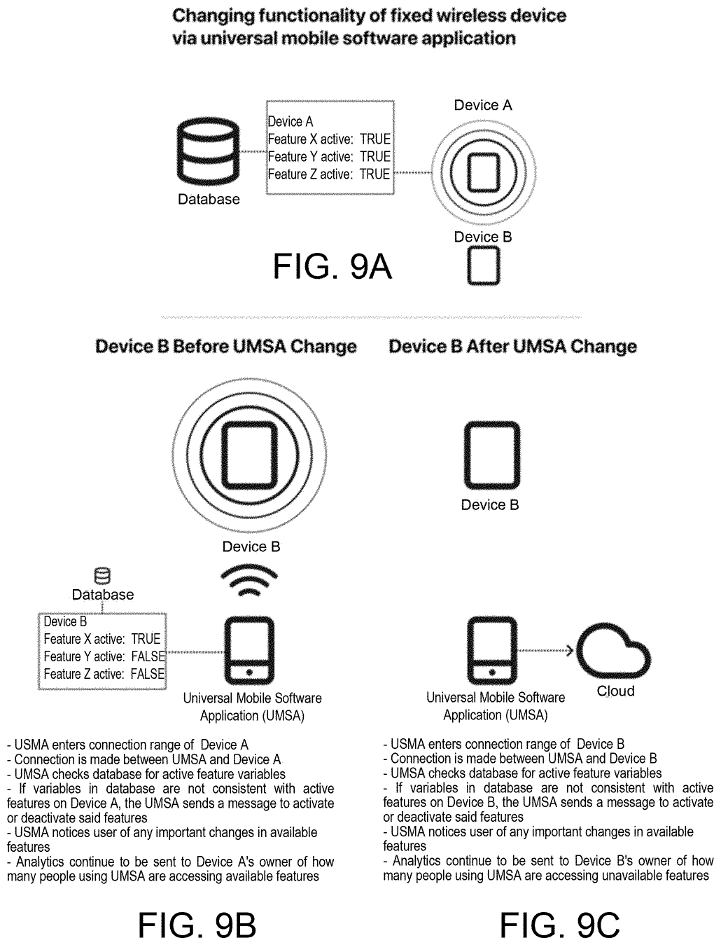

In various embodiments, and with reference to FIGS. 9A, 9B, and 9C, the automated door system disclosed herein may be configured to update hardware functionality. For example, door hardware (e.g., the first door control module) may be sold with an upfront cost to own the hardware along with a subscription to license the software required to keep the hardware up to date and provide functionality via software applications. In various embodiments, firmware/software updates to the second door control module may be triggered in response to the second door control module connecting with the first door control module. Said differently, the first door control module may ‘share’ or ‘push’ updates to the second door control module from time to time. If in the case the software subscription is canceled, there may arise the need to disable certain functionality of the software that is running on the provided hardware devices. If the provided hardware devices are not directly connected to the internet it may be challenging to deactivate the software remotely. It is not reasonable for the seller and not beneficial for the buyer to visit each individual hardware device and manually deactivate its software features that have been canceled.

In various embodiments, when the product's ecosystem includes various devices that enable its functionality (hardware receivers plus smartphone applications) including a software application that is universal to the product's ecosystem regardless of who owns the hardware receivers, it is not feasible to disable the software application for all users when only a subset of hardware receivers have had their software subscription canceled. The users of the universal software application may receive benefits from the use of some or all of the hardware receivers, of which a subset may be canceled unbeknownst to them. For the users' benefit, they should be aware of such cancellations as to inform them of the lost benefit from a particular subset of hardware receivers that a buyer has canceled.

The hardware devices may include, in various embodiments, variables in the software determining whether certain features are active or inactive. When a particular subset of the hardware receivers is canceled by a customer, the database containing information regarding the hardware receivers will be updated. When the universal mobile software application interacts with the hardware receivers it will check the hardware receiver information in the database and if the database information is inconsistent with the stored variables, the mobile application will update the hardware receiver to the latest information from the database which will update the hardware receiver's functionality.

Once the functionality is updated, the hardware receiver may notify users of the universal mobile application with a notification when they attempt to use the hardware receiver that its functionality has changed because it has been deactivated by the customer who first ordered it. This would inform the users that it is no longer active and could additionally inform the no longer paying customer of how often and how many people are continuing to try to use the system and are unable to benefit from it, encouraging the customer to begin paying their software subscription again. This process could also work in reverse to activate or reactivate new features if, for example, the customer begins to pay their software subscription again.

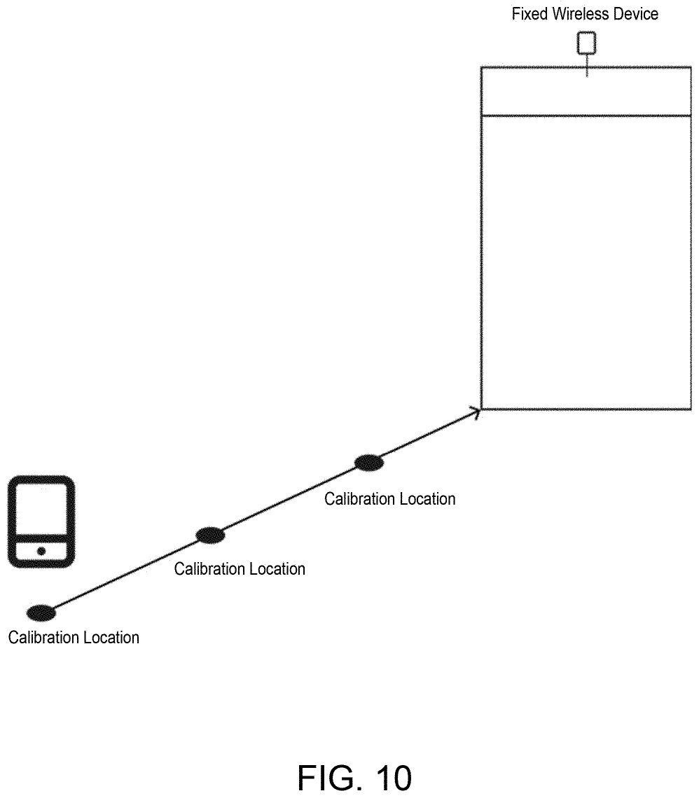

In various embodiments, and with reference to FIG. 10, the door opening/closing actuations may be calibrated. Wireless signals such as Bluetooth Low Energy (2.4 GHz) may be affected by physical objects and materials in their environment. The signal that is seen between two devices will vary based on signals that are attenuated and reflected by these environmental factors. When these factors are inherent or unavoidable, signal inconsistencies will lead to unpredictable performance. One method of addressing this issue may include using a separate device (i.e. mobile phone) where the fixed hardware device can calibrate its signal to each particular environment it may be installed. This could be done by connecting and taking a reading of the signal strength between the two devices. This may be done once or in multiple locations in the environment for the device to understand the signal strength in various locations. It is possible that these locations can be made known to the user or set by the user so that the devices can understand where they are be located relative to each other at each calibration point.

In a case where the fixed hardware device has multiple antennas, it can be useful for the fixed hardware device to understand the difference in signal between each of its antennas. By calibrating with a separate device (i.e. mobile phone) it can measure the difference in signal strength between its different antennas.

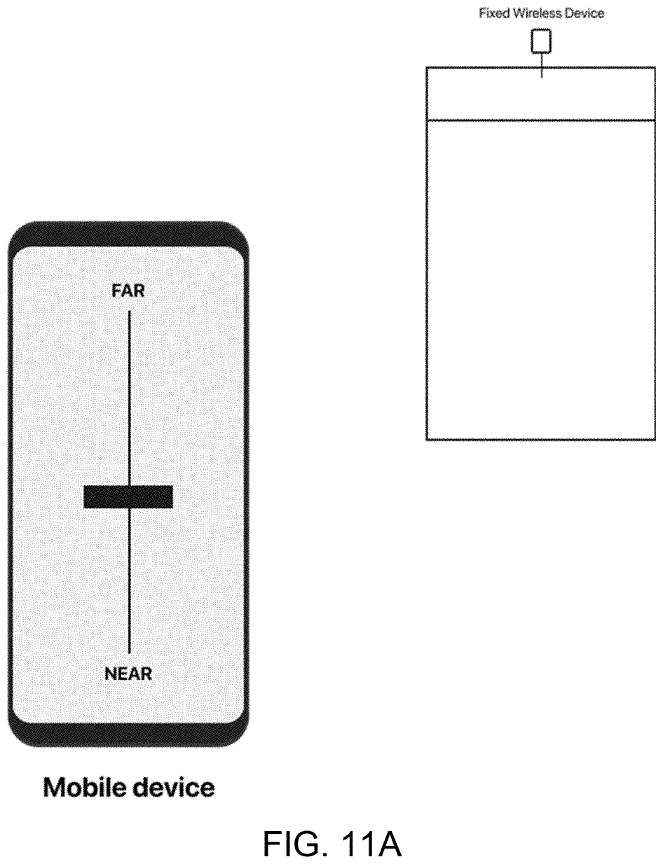

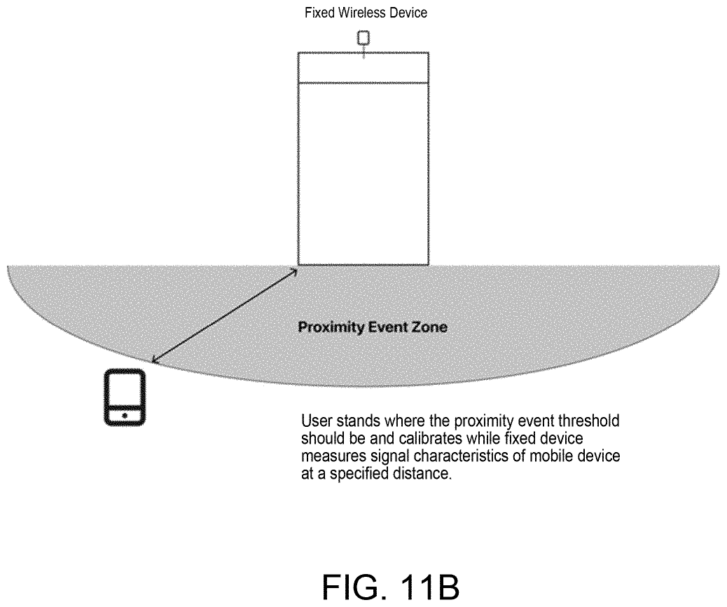

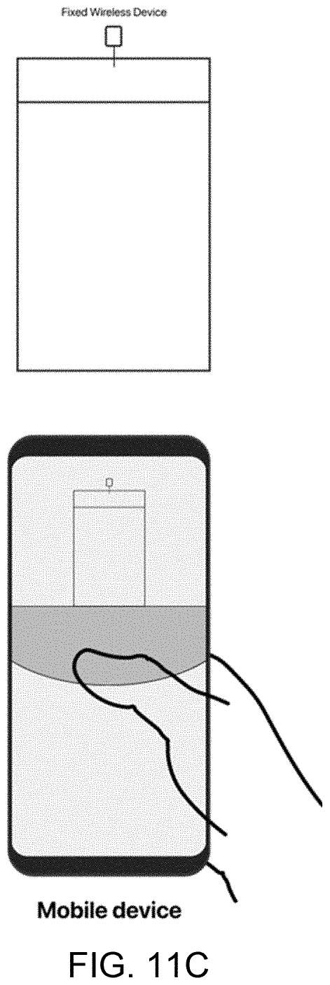

In various embodiments, and with reference to FIGS. 11A, 11B, and 11C, the automated door system may be calibrated/adjusted to have a desired opening distance. When using a wireless signal to provide a proximity enable event and/or when using one or more detectors/sensors (such as mm-wave radar, etc.), a user may want the ability to manually adjust the actuation settings. This is particularly true when setting an event to open an automatic door. In various embodiments, the user can adjust the opening distance by sending a wireless message including a new/updated baseline value to adjust the distance at which they would like the door to open or proximity event to happen. This value may affect the fixed hardware device in multiple ways.

The fixed hardware device may be affected by adjusting at least one of the transceiver power, wireless protocol settings or software settings to adjust the distance at which it will choose to open when a person is approaching the door or another proximity event. This proximity event distance setting may also be accomplished by the user standing at the distance they would like the proximity event to happen and the fixed hardware device taking readings of the mobile device's wireless signal and calibrating settings to occur when the mobile device enters that region.

Further, a person installing hardware that requires a distance setting may not have the ability to guess or the tools on hand to measure the exact distance they would like to set. They may also not be able to visualize what the opening distance setting will look like in real life. Because installers may be using a mobile device to adjust the opening distance, a mobile app can be used, in various embodiments, to allow them to see the opening distance radius in augmented or virtual reality. Augmented reality tools allow the app to know distance measurements using the mobile device's cameras and/or other sensors. This allows the installers to see visually where the opening distance lies on the ground in addition to adjusting the distance setting directly on their mobile device by manipulating it with pinch gestures, or slider or other means. This makes it easy to understand what the opening distance will look like, allows simple adjustments, and saves time. Thus, the operations performed by the automated door system may include displaying a virtual or augmented reality of the environment around a powered door on a screen of a portable electronic device carried by the user. The virtual/augmented reality displayed on the screen may allow for the user to visualize the timing of the door actuations, and may allow the user to customize and adjust the actuations based on user preference.

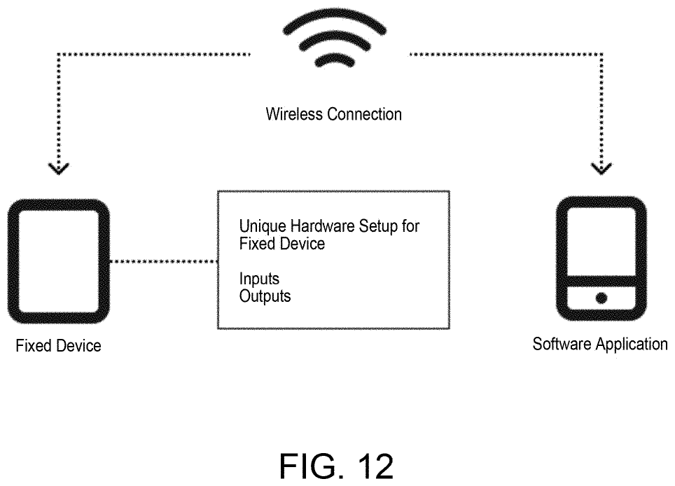

In various embodiments, and with reference to FIG. 12, an automated door system may have configurable inputs and/or outputs. For example, hardware devices that are plugged into doors may have limited functionality because the inputs and outputs have predefined functionality based on hardware settings or software that shipped on the device. In various embodiments, a device with hardware input and output ports may be configurable based on user input from a wireless device (i.e. smartphone app). In one method, users can use the mobile application to provide logic statements and rules that allow the hardware receiver to act in accordance with their unique preferences and installation. These logic statements may include but are not limited to reading input states, which may include a voltage or open or closed contact circuit as well as performing output functions which may include but are not limited to opening or closing a contact, sending data or applying power to output ports. They may also include combining states with time delays, using and/or/not statements, etc. Once these settings are saved, the user will have them recorded for convenient recall. In various embodiments, the application can also allow the user to save the wiring diagram of the hardware installation which can be very valuable when they or another person need to revisit that installation.

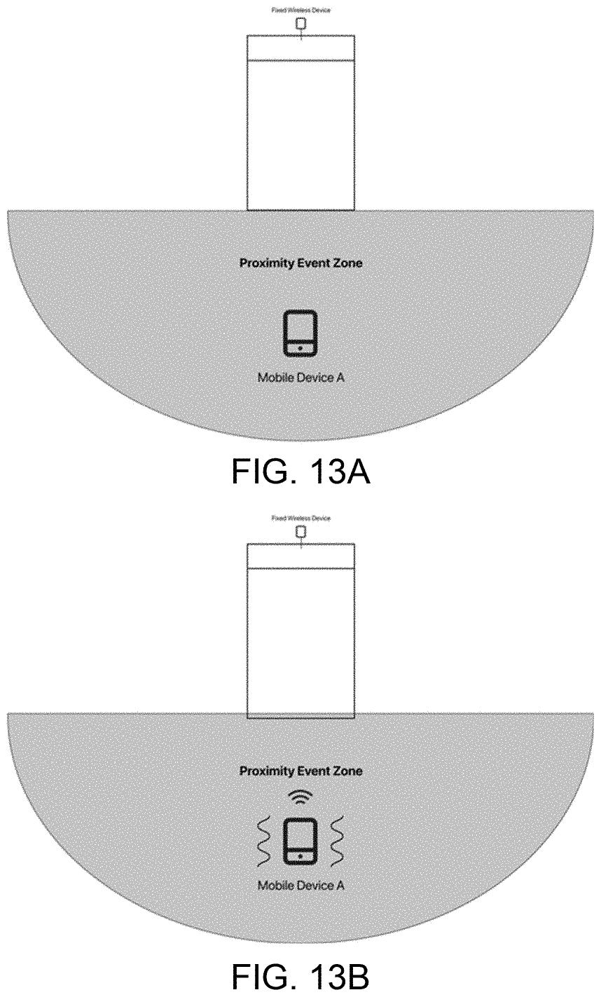

In various embodiments, and with reference to FIGS. 13A and 13B, the automated door system may be configured to optimize performance/operation based on specifics of a mobile device. For example, proximity enabled applications may include false positives (performing an action when a user does not want proximity-based action to occur) when the user remains in or around the zone where proximity event should happen. There may be situations in which the proximity event should only occur on entering or exiting the proximity zone. There may also be situations where the state of the proximity event should remain active when the user remains inside the zone. Another problem is that wireless signals may not always be accurate and will cause false positives when the user is outside of the preferred proximity zone because of signal fluctuations.

In various embodiments, additional indicators may be taken into account when making these proximity-based decisions. For a proximity event to cause a door to open, an accelerometer of a mobile device that the user has on their person can be used to determine whether or not they are moving. When the accelerometer data suggests that they are not moving, the app can be disabled to prevent false positives from occurring because if they are not moving for a certain amount of time, the automated door system can infer that the user has no intention of passing through a door, in which case the door should not be opened. When the accelerometer data suggests they are moving the app will be active as we can assume that they have the intention of passing through a door when they are within the proximity region.

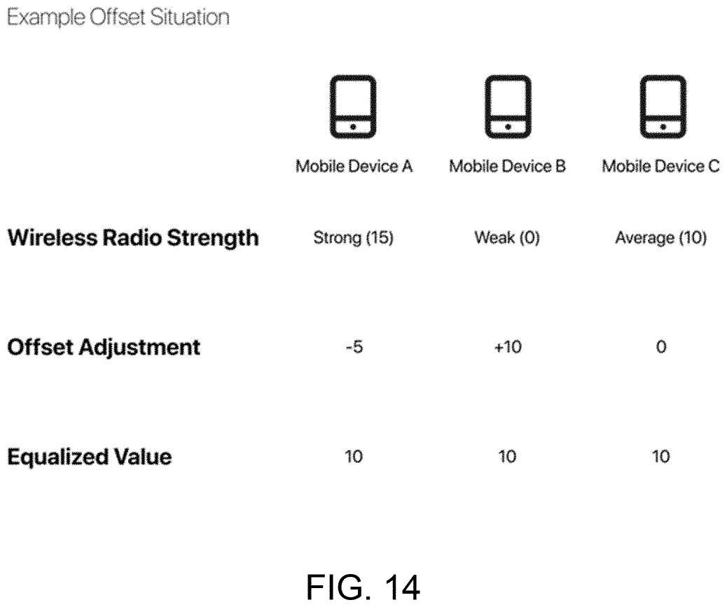

In various embodiments, and with reference to FIG. 14, this optimization/calibration based on properties of the mobile device may be further improved by considering manufacturer/model-based offset adjustments. For example, FIG. 14 is a table that provides illustrative properties for different example mobile devices. Different makes/models of mobile devices come with varying wireless signal characteristics. These varying characteristics cause inconsistencies in experiences between users who carry different mobile devices, especially with experiences that rely on signal strength characteristics.

In various embodiments, an offset adjustment can be used based on the make/model of the mobile device being used. These offsets may be calculated by setting up a test environment and testing each phone and its signal strength characteristics (including RSSI and RSSI variance). When the user is interacting with a wireless hardware device, the application running on the mobile device can check at least one of its make/model and share the appropriate offset for that particular make/model. This will compensate for the varying wireless signal characteristics of each mobile phone make/model and help improve the accuracy and reliability of the proximity determination.

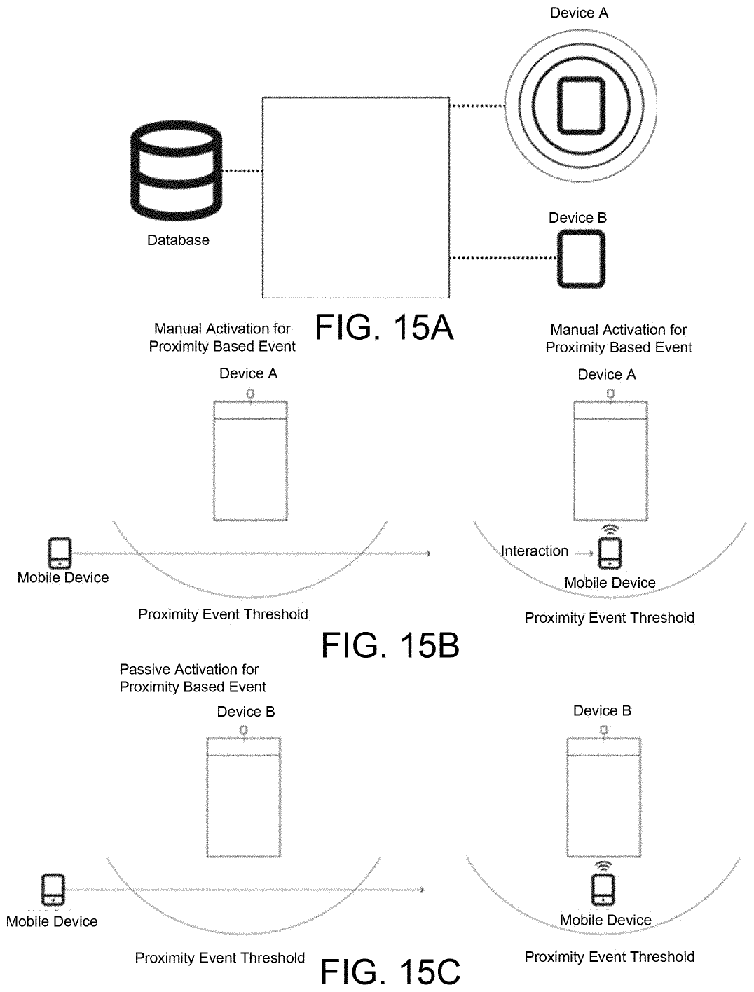

In various embodiments, and with reference to FIGS. 15A, 15B, and 15C, different operating modes of an automated door system are provided. For example, when using proximity-based and passive hands-free applications it is difficult to understand the intention of the user which may cause unintended actions when a user enters a proximity zone and does not intend for the proximity-based action to occur. Accordingly, in various embodiments, a setting may be chosen on the fixed hardware device that usually performs proximity-based actions to be set to only perform that action when a user explicitly tells it to. This setting may be set for only certain conditions or certain contexts (e.g., time of day, who/what type of user, the type of door, etc.) or can be set indefinitely until the setting is changed. It can also only be set for particular types of users.

When the manual action setting is on, the user may perform an action in order for the first door control module to perform a desired actuation. This prevents fixed hardware devices from performing unintended actions in situations where it is not reasonable to perform actions based on passive hands-free proximity (i.e. opening a restroom door for a restroom where hallway or restroom stalls may fall within the proximity zone where users would not like door opening action to occur when they are traveling through a hallway or using the restroom stall). Manual actions to tell the door to open may include but are not limited to, tapping on the phone screen and using the phone's accelerometer to detect determined tap sequences, pressing a button on a mobile application, voice commands using digital assistant programs or other means, performing a manual action like waiting in front of the door for a determined length of time or positioning or gesturing the user's hands or body in certain configurations, or selecting a particular action from a specific nearby device using a mobile application. Thus, as mentioned above, the automated door system may include one or more sensors/detectors, such as physical presence sensors and motion detection sensors, and the automated door system may be configured to perform an actuation in response to a user positioning or gesturing in a predetermined manner (waving, posing, grabbing a handle, etc).

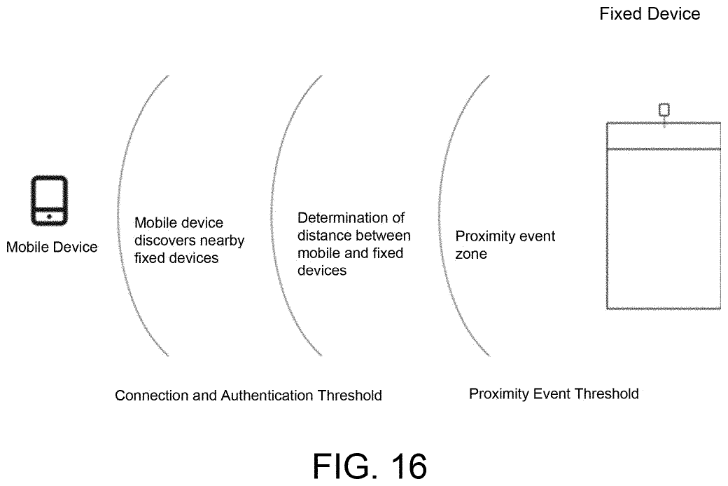

In various embodiments, and with reference to FIG. 16, methods and systems for reducing latency are provided. For example, mobile devices that run different operating systems like iOS and Android have different wireless protocols (e.g., different Bluetooth stacks, ultra wideband, thread, etc.) which determine how quickly they can connect. Android, in particular and according to various embodiments, may be slower than other operating systems, and may take over 3-5 seconds to connect and send a Bluetooth message. In situations where the user requires an action to occur based on a Bluetooth message, they may not want to wait 3-5 seconds for the connection to be made and the message sent.

In various embodiments, the mobile hardware device first connects at a distance further than the actuation distance to the fixed hardware device and “authenticates.” Thus, the automated door system may be configured to perform an initial connection and authentication step before perform an actuation. After initial connection/authentication, the first door control module may begin reading values from the second door control module (e.g., the mobile hardware device) to determine its distance and when the fixed hardware device should perform an actuation. By connecting and authenticating prior to the point in time where an action should be performed, latency is reduced so that the user does not need to wait for connection and authentication to be made at the time the action should be performed. Similar early authentication can be performed via other sensors/detectors, thus generally handling the initial authentication and/or data analysis to be performed before the triggering/proximity event occurs, thus reducing latency of actuation and improving how quickly the actuation is communicated once the triggering event/condition is satisfied.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure.

Reference throughout this specification to features, advantages, or similar language does not imply that all of the features and advantages that may be realized with the present disclosure should be or are in any single embodiment of the invention. Rather, language referring to the features and advantages is understood to mean that a specific feature, advantage, or characteristic described in connection with an embodiment is included in at least one embodiment of the subject matter disclosed herein. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the subject matter of the present application may be practiced without one or more of the specific features or advantages of a particular embodiment. In other instances, additional features and advantages may be recognized in certain embodiments that may not be present in all embodiments of the disclosure. Further, in some instances, well-known structures, materials, or operations are not shown or described in detail to avoid obscuring aspects of the subject matter of the present disclosure. No claim element is intended to invoke 35 U.S.C. 112(f) unless the element is expressly recited using the phrase “means for.”

The scope of the disclosure is to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one and that reference to an item in the singular may also include the item in the plural. Further, the term “plurality” can be defined as “at least two.” As used herein, the phrase “at least one of”, when used with a list of items, means different combinations of one or more of the listed items may be used and only one of the items in the list may be needed. The item may be a particular object, thing, or category. Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A, B, and C. In some cases, “at least one of item A, item B, and item C” may mean, for example, without limitation, two of item A, one of item B, and ten of item C; four of item B and seven of item C; or some other suitable combination.

All ranges and ratio limits disclosed herein may be combined. Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Different cross-hatching may be used throughout the figures to denote different parts but not necessarily to denote the same or different materials. Surface shading lines may be used throughout the figures to denote different parts or areas but not necessarily to denote the same or different materials. In some cases, reference coordinates may be specific to each figure. Furthermore, the connecting lines shown in the various figures contained herein are intended to represent exemplary functional relationships and/or physical couplings between the various elements. It should be noted that many alternative or additional functional relationships or physical connections may be present in a practical system.

Any reference to attached, fixed, connected or the like may include permanent, removable, temporary, partial, full and/or any other possible attachment option. Additionally, any reference to without contact (or similar phrases) may also include reduced contact or minimal contact. In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

The schematic flow chart diagrams included herein are generally set forth as logical flow chart diagrams. As such, the depicted order and labeled steps are indicative of one or more embodiments of the presented method. The steps recited in any of the method or process descriptions may be executed in any order and are not necessarily limited to the order presented. Furthermore, any reference to singular includes plural embodiments, and any reference to more than one component or step may include a singular embodiment or step. Elements and steps in the figures are illustrated for simplicity and clarity and have not necessarily been rendered according to any particular sequence. Other steps and methods may be conceived that are equivalent in function, logic, or effect to one or more steps, or portions thereof, of the illustrated method.

Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. Furthermore, no element, component, or method step in the present disclosure is intended to be dedicated to the public regardless of whether the element, component, or method step is explicitly recited in the claims.

The subject matter of the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An automated door system comprising:
a first antenna configured to be mounted to a first side of a powered door;
a second antenna configured to be mounted to a second side of the powered door opposite the first side; and
a first door control module comprising a processor and configured to be mounted in a fixed position relative to the powered door, wherein the processor is configured to communicate with a tangible, non-transitory memory having instructions stored thereon that, in response to execution by the processor, cause the automated door system to perform various operations;
wherein the operations comprise wirelessly connecting, by the processor, the first door control module to a second a second door control module, configured to be carried by a user, via at least one of the first antenna and the second antenna;
wherein the operations comprise performing at least one actuation of the powered door.

2. The automated door system of claim 1, wherein the at least one actuation of the powered door comprises at least one of a closing actuation, an opening actuation, an unlocking actuation, and a locking actuation.

3. The automated door system of claim 1, wherein the various operations comprise receiving and comparing data from the first antenna and the second antenna to determine on which side of the powered door the second door control module is located.

4. The automated door system of claim 1, wherein the operations comprise receiving and comparing a data from the first antenna and the second antenna to determine a proximity of the user relative to the powered door.

5. The automated door system of claim 4, wherein the receiving and comparing the data from the first antenna and the second antenna comprises performing an angle of arrival calculation for timing and accuracy of the at least one actuation of the powered door.

6. The automated door system of claim 4, wherein the receiving and comparing the data from the first antenna and the second antenna comprises determining an extent of reflective signal noise and calibrating or adjusting timing and accuracy of the at least one actuation of the powered door based on the extent of reflective signal noise.

7. The automated door system of claim 1, further comprising a third door control module configured to be mounted in a fixed position relative to the powered door, wherein the third door control module is configured to be coupled to a button that is depressible for manual control of the at least one actuation of the powered door.

8. The automated door system of claim 7, wherein the third door control module comprises an electric generator mechanism that is configured to generate electricity in response to manual depression of the button.

9. The automated door system of claim 7, wherein the third door control module is configured to be in electronic communication with the first door control module, wherein the operations comprise at least one of tracking button depression data and reporting the button depression data to a server.

10. The automated door system of claim 4, further comprising a detector configured to detect a presence of the user relative to the powered door, wherein the operations comprise receiving, by the processor, position data pertaining to the user from the detector, wherein performing, by the processor, the at least one actuation is performed in response to both the position data and the data from the first antenna and the second antenna.

11. An automated door system comprising:
a detector configured to detect a presence of a user relative to a powered door; and
a first door control module comprising a processor and configured to be mounted in a fixed position relative to the powered door, wherein the processor is configured to communicate with a tangible, non-transitory memory having instructions stored thereon that, in response to execution by the processor, cause the automated door system to perform various operations;
wherein the operations comprise receiving, by the processor, position data pertaining to the user from the detector;
wherein the operations comprise controlling, by the processor, at least one actuation of the powered door based on the position data.

12. The automated door system of claim 11, wherein the at least one actuation of the powered door comprises at least one of a closing actuation, an opening actuation, an unlocking actuation, and a locking actuation.

13. The automated door system of claim 11, wherein the detector comprises at least one of a camera, a radar detector, a lidar detectors, an infrared sensor, a microwave sensor, and a machine-perception device.

14. The automated door system of claim 11, further comprising:
a first antenna configured to be mounted to a first side of the powered door; and
a second antenna configured to be mounted to a second side of the powered door opposite the first side.

15. The automated door system of claim 14, wherein the various operations comprise receiving and comparing data from the first antenna and the second antenna to determine on which side of the powered door the user is located.

16. The automated door system of claim 14, wherein the operations comprise receiving and comparing data from the first antenna and the second antenna to determine a proximity of the user relative to the powered door.

17. The automated door system of claim 16, wherein the receiving and comparing the data from the first antenna and the second antenna comprises performing an angle of arrival calculation for timing and accuracy of the at least one actuation of the powered door.

18. A method of controlling a powered door, the method comprising:
wirelessly electronically connecting, by at least one of a first processor of a first door control module that is mounted in a fixed position relative to the powered door and a second processor of a second door control module, the second door control module to the first door control module via a first antenna and a second antenna;
receiving, by at least one of the first processor and the second processor, data from the first antenna and the second antenna to determine on which side of the powered door the second door control module is located;
determining, by at least one of the first processor and the second processor and based on the data from the first antenna and the second antenna, a proximity of the second door control module to the first door control module; and
in response to determining the proximity of the second door control module to the first door control module, actuating, by at least one of the first processor and the second processor, the powered door.

19. The method of claim 18, wherein:
the first antenna is mounted to a first side of the powered door;
the second antenna is mounted to a second side of the powered door opposite the first side; and
the second door control module comprises an application stored on a portable electronic device of a user and the portable electronic device comprises the second processor.

20. The method of claim 19, wherein determining the proximity of the second door control module to the first door control module comprises performing an angle of arrival calculation of the second door control module.
